(19) United States
(12) Patent Application Publication
(10) Pub. No.: US 2008/0084690 A1
(43) Pub. Date: Apr. 10, 2008

(54) UNIVERSAL WALKER HEADLIGHT

(76) Inventor: Philip L. Rappl, San Diego, CA (US)

Correspondence Address: CHRISTIE, PARKER & HALE, LLP, PO BOX 7068, PASADENA, CA, 91109-7068, US

(21) Appl. No.: 11/856,626

(22) Filed: Sep. 17, 2007

Related U.S. Application Data
(60) Provisional application No. 60/826,095, filed on Sep. 19, 2006.

(51) Int. Cl. F21L 4/02; F21L 4/00

(52) U.S. Cl. 362/184; 362/191

(57) ABSTRACT

The universal walker headlight is a lightweight, portable light source adapted for easy attachment to the frame of any walker or rollator. The universal walker headlight uses low power, high brightness light emitting diodes (LEDs) to extend battery life. The universal walker headlight simultaneously illuminates both the area in front of the walker or rollator, and the feet area below the walker or rollator.

### CROSS-REFERENCE TO RELATED APPLICATION

This is an ordinary application of Provisional Application No. 60/826,095, filed Sep. 19, 2006, the contents of which are expressly incorporated herein by reference.

The present invention relates generally to illumination and relates specifically to a portable headlight adapted for attachment to a walker or rollator.

### BACKGROUND

Old age, medications, and medical conditions can cause muscle weakness and balance problems. Muscle weakness and balance problems can make mobility difficult and can increase the risk of falling. Falling can cause fractures and other serious injuries, particularly to people with conditions often associated with old age such as osteoporosis. People with muscle weakness and balance problems often use a walker or rollator (a walker with wheels) to enhance mobility and reduce the risk of falling.

Poor lighting is another factor that increases the risk of falling. Good lighting helps people avoid obstacles and tripping hazards. Good ambient lighting is not always available. A light switch may be across the room, or a light bulb may be burned out. Sometime, especially outside at night, no lighting is available at all. Handheld flashlights are known in the art for providing a portable light source.

Handheld flashlights are impractical for people who require use of both hands to operate a walker or rollator. People using a walker or rollator need illumination of the path ahead to see where they are going. People using a walker or rollator also need illumination of the area beneath the walker or rollator to see where they are placing their feet. A need exists for a lightweight, portable light source that can be affixed to a walker or rollator. The portable light source should be easy to turn on and off, should use power efficiently, should illuminate a path ahead of the walker or rollator and should illuminate the area beneath the walker or rollator.

### SUMMARY

The universal walker headlight is a lightweight, portable light source adapted for easy attachment to the frame of any walker or rollator. The universal walker headlight uses low power, high brightness light emitting diodes (LEDs) to extend battery life. The universal walker headlight simultaneously illuminates both the area in front of the walker or rollator, and the feet area below the walker or rollator.

### BRIEF DESCRIPTION OF DRAWINGS

The novel features believed characteristic of the invention are set forth in the appended claims. Aspects of the invention themselves, as well as preferred modes of use, further objectives, and advantages thereof, will be understood best by reference to the following detailed description of illustrative embodiments when read in conjunction with the accompanying drawings, wherein:

FIG. 1A is a perspective view of the universal walker headlight;

FIG. 1B is a view of the bottom of universal walker headlight;

FIG. 1C shows the universal walker headlight attached to a walker;

FIG. 2 is another perspective view of the universal walker headlight;

FIG. 3 is a view of the top of the universal walker headlight;

FIG. 4 is a side view of the universal walker headlight;

FIG. 5 is a view of the back of the universal walker headlight;

FIG. 6 is an alternate configuration of the universal walker headlight;

FIG. 7 is a functional diagram of the universal walker headlight; and

FIG. 8 shows features of the universal walker headlight.

### DETAILED DESCRIPTION

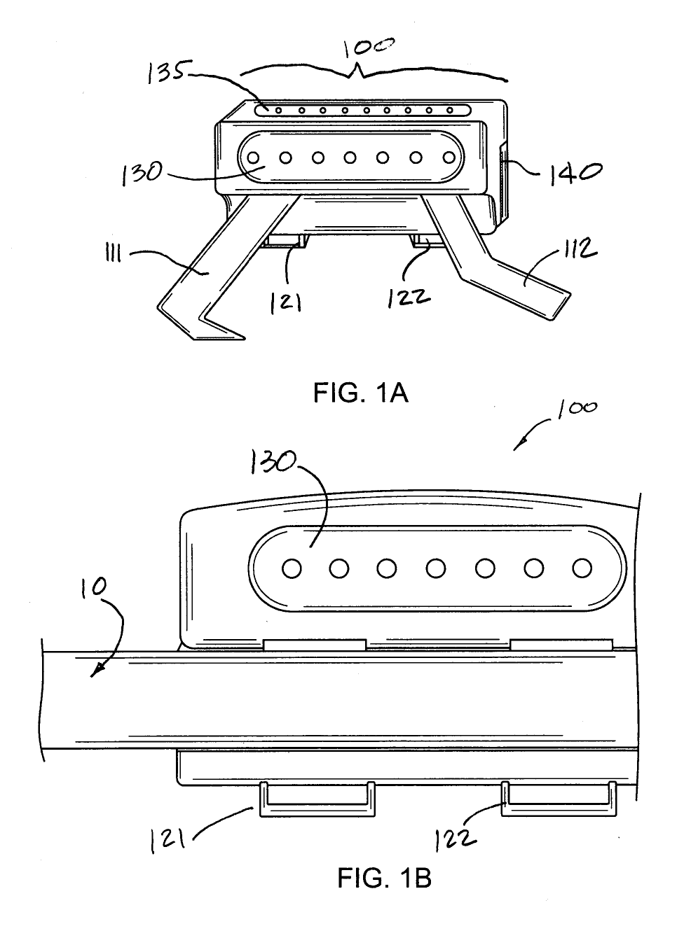

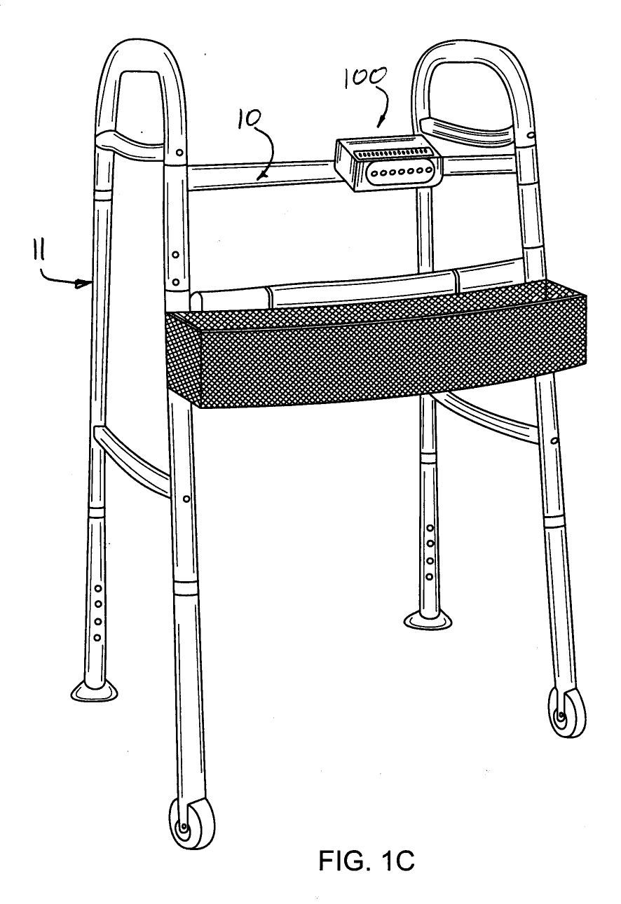

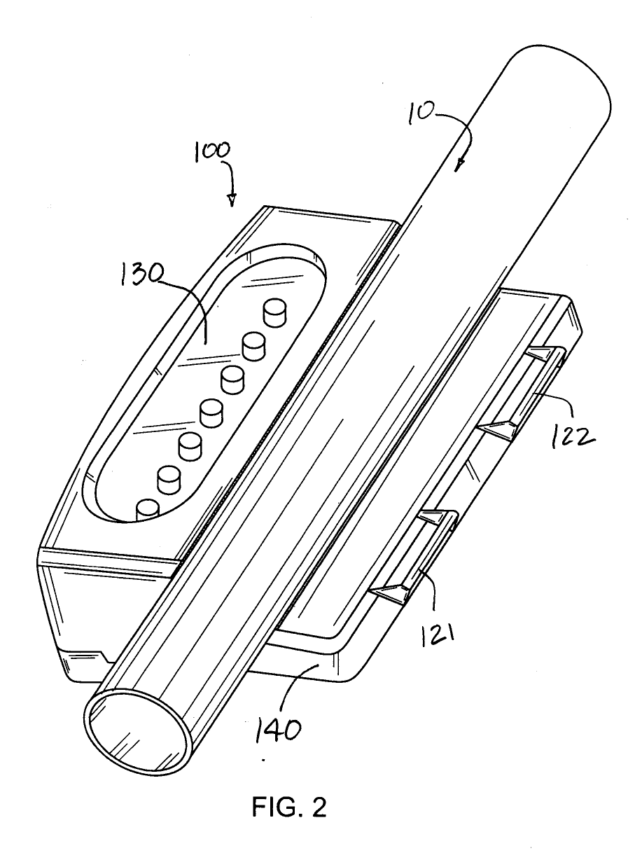

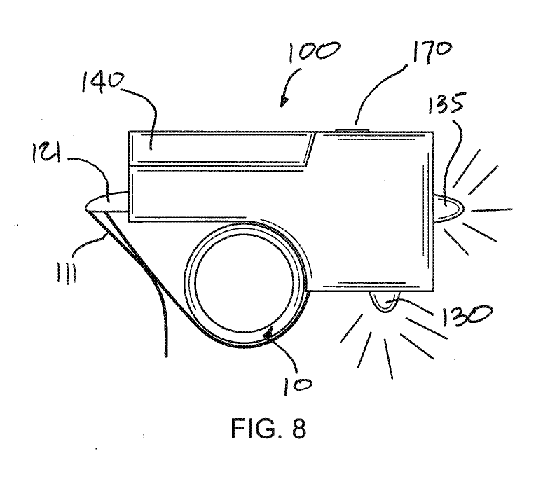

Universal walker headlight 100 is shown in FIG. 1A. First light source 130 and second light source 135 are oriented at a ninety degree angle from each other, as described in FIG. 8. In a preferred embodiment, first light source 130 and second light source 135 each comprise a row of individually mounted light emitting diodes (LEDs). LEDs are a preferred light source because they have a long life and consume lower amounts of power compared to other light sources with the same brightness. In another embodiment, first light source 130 and second light source 135 each comprises at least two individually mounted LEDs, such as three LEDs or four LEDs. Alternatively, the first light source 130 and the second light source 135 can each comprise of other light sources known in the art, such as incandescent, fluorescent, halogen light bulbs, or combinations thereof. Panel 140 can be removed to access an internal battery compartment. The fixed ends of first strap 111 and second strap 112 are attached near the midpoint on the body of universal walker headlight 100. The loose ends of first strap 111 and second strap 112 can be affixed to tab 121 and tab 122 respectively, for securing universal walker headlight 100 to a walker. The loose ends of first strap 111 and second strap 112 can be made of hook and loop fasteners or can use buckles or other known fastening means for securing universal walker headlight 100 to a walker. When used to mount the universal walker headlight 100 to a walker or a rollator, part of the fastening device goes around a section of the walker or the rollator and the other part or parts of the fastening device is secured to the universal walker headlight, FIG. 1B shows universal walker headlight 100 positioned on tube 10. Tube 10 is a structural member of a walker or rollator. FIG. 1C shows universal walker headlight 100 coupled to tube 10, a horizontal member on walker 11.

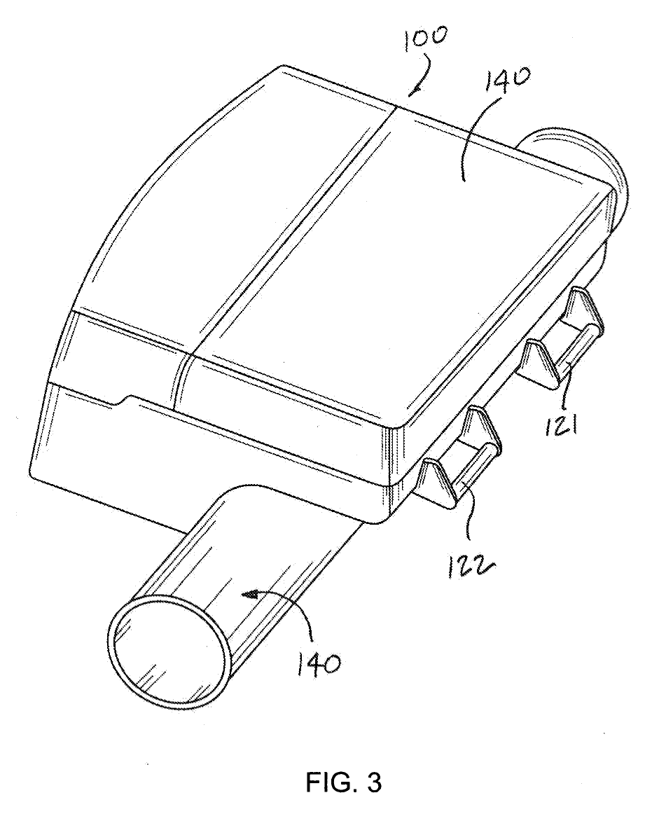

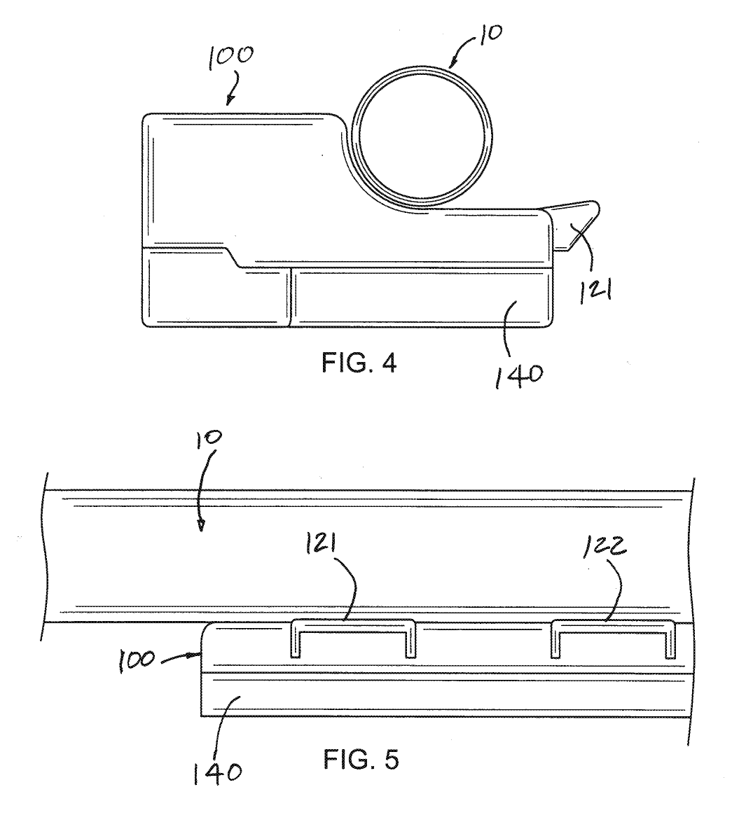

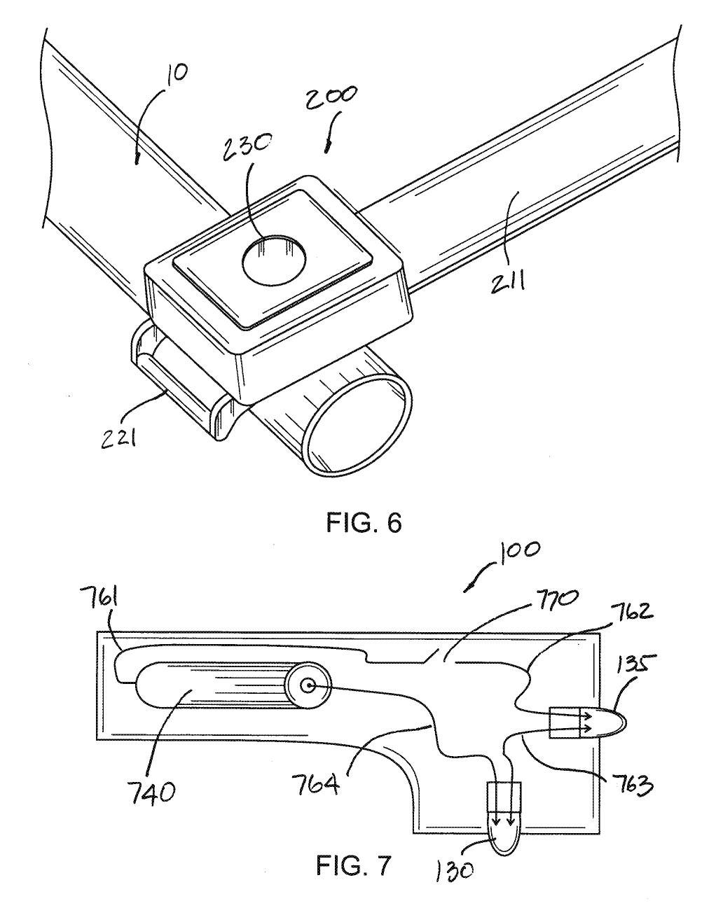

Additional perspective views of universal walker headlight 100 positioned on tube 10 are shown in FIG. 2, FIG. 3, FIG. 4, and FIG. 5. FIG. 2 shows the bottom of universal walker headlight 100. FIG. 3 shows a top view of the universal walker headlight. FIG. 4 shows a side view of the universal walker headlight. FIG. 5 shows a view of the back of the universal walker headlight. FIG. 6 shows universal walker headlight 200, an alternate configuration of the invention. Universal walker headlight 200 is a compact embodiment utilizing a single strap 211 and a single tab 221 for coupling universal walker headlight 200 to tube 10. Single light source 230 is on the opposite side of universal walker headlight 200 from strap 211 and tab 221.

FIG. 7 shows a functional diagram of universal walker headlight 100. Power source 740 is shown as a standard dry cell battery. A first electrode of power source 740 connects to switch 770 via electrical connection 761. A second electrode of power source 740 connects to first light source 130 via electrical connection 764. First light source 130 is connect in series to second light source 135 via electrical connection 763. Switch 770 connects to second light source 135 via electrical connector 762. When switch 770 is closed, first light source 130 and second light source 135 are supplied with power from power source 740, turning universal walker headlight 100 on. When switch 770 is opened, no power reaches first light source 130 and second light source 135, turning universal walker headlight 100 off. In another embodiment of universal walker headlight 100, switch 770 is coupled with an electric eye, automatically closing whenever the ambient light is low to turn universal walker headlight 100 on. Although universal walker headlight 100 is shown here with first light source 130 and second light source 135 wired in series, a parallel circuit could be used. In an alternate embodiment of universal walker headlight 100, switch 770 allows a user to turn on first light source 130 and second light source 135 independently from each other, depending on the desired illumination pattern.

FIG. 8 shows features of universal walker headlight 100 from the side. Universal walker headlight 100 couples to horizontal tube 10 by first strap 111. The loose end of first strap 111 loops through first tab 121 located on the back side of universal walker headlight, then attaches to itself with hook and loop fasteners. Alternate embodiments of first strap 111 can attached to the main body of universal walker headlight 100 with hook and loop fasteners, or other known fastening devices such as buckles, clips, or snaps. In other embodiments, universal walker headlight 100 couples to horizontal tube 10 with two-sided adhesive tape, clamps, clips or screws. Grooves, teeth or rubberized pads may be added to the curved portion on the bottom side of universal walker headlight 100 to prevent rotation around tube 10. First light source 130 shines from the bottom of universal walker headlight 100 to illuminate that area around the base of a walker or rollator to assist users when placing feet. Second light source 135 shines from the front of universal walker headlight 100 to illuminate a path ahead of a walker or rollator. Concave mirrored surfaces above first light source 130 and behind second light source 135 can help focus and direct light in the desired directions. In an alternate embodiment, a single light source with a concave mirrored surface can direct light both below and in front of a walker or rollator. Switch 170 is located on the top of universal walker headlight 100 for easy access, but can also be placed on the back or sides. Panel 140 on the top of universal walker headlight 100 is removable to facilitate replacing an internal power source, such as a dry cell battery.

A preferred form of the invention has been shown in the drawings and described above, but variations in the preferred form will be apparent to those skilled in the art. The preceding description is for illustration purposes only, and the invention should not be construed as limited to the specific form shown and described. The scope of the invention should be limited only by the language of the following claims.

What is claimed is:

1. A portable headlight for a walker, the headlight comprising:
a casing adapted to fit on a walker;
a fastening device adapted to hold the casing onto the walker;
a light source in the casing that illuminates an area in front of the walker and an area below the walker;
a power supply connected to the light source; and
a switch for interrupting the power supply to the light source.

2. The portable headlight of claim 1, wherein the casing has a generally planar area and a curved recess area adapted to fit on a horizontal bar on the front of the walker.

3. The portable headlight of claim 1, wherein the fastening device comprises a strap with hook and loop fasteners.

4. The portable headlight of claim 1, wherein the light source comprises a plurality of LEDs.

5. The portable headlight of claim 1, wherein the power supply is a battery.

6. A portable headlight for a walker, the headlight comprising:
a casing adapted to fit on a walker;
a fastening device adapted to hold the casing onto the walker;
a first light source mounted in the front of the casing that illuminates an area in front of the walker;
a second light source mounted in bottom of the casing that illuminate an area below the walker;
a power supply connected to the light source; and
a switch for interrupting the power supply to the light source.

7. The portable headlight of claim 6, wherein the casing has a generally planar area and a curved recess area adapted to fit on a horizontal bar on the front of the walker.

8. The portable headlight of claim 6, wherein the fastening device comprises a strap with hook and loop fasteners.

9. The portable headlight of claim 6, wherein the light source comprises a plurality of LEDs.

10. The portable headlight of claim 6, wherein the power supply is a battery.

11. The portable headlight of claim 9, wherein the plurality of LEDs are connected in series.

12. The portable headlight of claim 9, wherein the plurality of LEDs are connected in parallel.

13. A method for mounting a portable headlight to a walker comprising:
providing a walker having a support section for supporting a user;
placing a casing section of the portable headlight against a generally elongated section of the walker;
securing the portable headlight to the generally elongated section of the walker by placing a fastening device around at least a portion of the walker and securing the fastening device to the portable headlight.

14. The method of claim 13, further comprising activating a switch to provide power to the portable headlight for illuminating an area around the walker.

15. The method of claim 13, wherein the portable headlight comprises two sets of light sources.

16. The method of claim 13, wherein the fastening device comprises a strap comprising hook and loop fastening means.

17. The method of claim 13, wherein the portable headlight further comprises an electric eye for sensing low ambient light condition.

18. The method of claim 13, wherein the portable headlight further comprises a switch for interrupting a power supply to a light source

19. The method of claim 13, further comprising the step of removing a panel on the portable headlight and inserting a battery for supplying the portable headlight with DC power.

20. The method of claim 13, wherein the casing section comprises a curve recessed section for mating against a round surface of the generally elongated section of the walker.
